(19) United States
(12) Patent Application Publication
(10) Pub. No.: US 2025/0035785 A1
(43) Pub. Date: Jan. 30, 2025

(54) Optoelectronic sensor and method of detecting objects in a monitored zone

(71) Applicant: SICK AG, Waldkirch (DE)

(72) Inventors: Gerold FEISE, Waldkirch (DE); Guido NEUENFELDT, Waldkirch (DE)

(21) Appl. No.: 18/776,662

(22) Filed: Jul. 18, 2024

(30) Foreign Application Priority Data
Jul. 25, 2023 (DE) 102023119716.9

(51) Int. Cl. G01S 17/42; G01B 11/26; G01D 5/347; G01S 7/481; G01S 7/4865

(52) U.S. Cl. CPC G01S 17/42; G01B 11/26; G01D 5/34707; G01S 7/4814; G01S 7/4817; G01S 7/4865

(57) ABSTRACT

An optoelectronic sensor for the detection of objects in a monitored zone has a light transmitter for transmitting a transmitted light beam, a scanning unit rotatable about an axis of rotation for the periodic scanning of the monitored zone by the transmitted light beam, a light receiver for generating a received signal from light beams remitted by objects in the monitored zone, an angle measurement unit for determining the angular position of the scanning unit relative to the sensor, and an evaluation unit that is configured to generate measured values with reference to the received signal that indicate whether and in which direction an object has been detected. A device is configured to determine an angular speed of the scanning unit about the axis of rotation and a correction unit is configured to determine a self-rotation of the sensor with respect to the axis of rotation of the scanning unit.

The invention relates to an optoelectronic sensor and to a method of detecting objects in a monitored zone respectively.

In a laser scanner, a light beam generated by a laser periodically sweeps over a monitored zone with the help of a scanning unit. The light is remitted at objects in the monitored zone and is evaluated in the laser scanner. A conclusion is drawn on the angular location of the object from the angular position of the scanning unit and additionally on the distance of the object from the laser scanner from the time of flight while using the speed of light. In this respect, two general principles are known to determine the time of flight. In phase-based processes, the transmitted light is modulated and the phase shift of the received light with respect to the transmitted light is evaluated. In pulse-based processes, the laser scanner measures the time of flight until a transmitted light pulse is received again. The location of an object in the monitored zone is detected in two-dimensional polar coordinates using the angular data and the distance data.

The scanning of the monitored zone in a laser scanner is typically achieved in that the transmitted beam is incident onto a rotating deflection mirror. The light transmitters, light receiver, and associated electronics and optics are installed fixedly in the device here and do not co-execute the rotary movement. However, it is also known to replace the deflection mirror with a scanning unit which is co-moved. For example in DE 197 57 849 B4, the entire measurement head with the light transmitter and light receiver rotates. EP 2 388 619 A1 likewise provides a rotatable transmission/reception unit. This scanning unit is supplied with energy from the rotationally fixed zones of the sensor in accordance with the transformation principle, for example.

In addition to measurement applications in which object positions or object contours are detected, laser scanners are also used in safety engineering for monitoring a danger source such as a dangerous machine represents. Such a safety laser scanner is known from DE 43 40 756 A1. In this process, a protected field is monitored which may not be entered by operators during the operation of the machine. If the laser scanner recognizes an unauthorized protected field intrusion, for instance a leg of an operator, it triggers an emergency stop of the machine. Other intrusions into the protected field, for example by static machine parts, can be taught as permitted in advance. Warning fields are frequently disposed in front of the protected fields where intrusions initially only result in a warning to prevent the protected field intrusion and thus a shutdown in good time and so to increase the availability of the plant. Safety laser scanners usually work as pulse-based.

Sensors used in safety engineering have to work particularly reliably and must therefore satisfy high safety demands, for example the EN13849 standard for safety of machinery and the machinery standard EN61496 for electrosensitive protective equipment (ESPE). A number of measures have to be taken to satisfy these safety standards such as a safe electronic evaluation by redundant, diverse electronics, function monitoring or specifically monitoring the contamination of optical components, in particular of a front screen, and/or provision of individual test targets with defined degrees of reflection which have to be recognized at the corresponding scanning angles.

A special demand is made in safety engineering applications in which the laser scanner is moved. This takes place, for example, in the safeguarding of vehicles, in particular of autonomous vehicles (driverless transport systems, AGVs, AGCs). For example, the laser scanner provides that the vehicle does not collide with objects or persons in that protected fields are above all monitored for intrusions in the direction of travel, but also laterally and, under certain circumstances, even to the rear.

The defined object resolution in the protected fields also has to be ensured under the influence of movements. The angular resolution predefined by the rotational movement of the scanning unit is here superposed with the outer movement. Possible impairments of the angular resolution in particular occur with abrupt rotational movements originating close to the axis of rotation of the scanning unit. Such movements occur, for example, in transport systems having an omnidirectional drive in which special wheel designs provide the possibility of being able to rotate on the spot and to move in any direction starting from the actual movement.

A safety laser scanner has to recognize when the object resolution is impaired due to such influences and to output a shutdown signal in good time. Conventionally, for this purpose, the rotational movement of the scanning unit is monitored by an angular encoder. The angular resolution drops at higher rotational speeds under conditions that are otherwise the same. If a stored reserve is exceeded here, this results in a shutdown. However, this is an indirect and inexact procedure to intercept the influence of outer movements. A short, abrupt movement of the laser scanner frequently already results in a shutdown without the object resolution having deteriorated at all in a safety related manner. The availability of the system is thus unnecessarily restricted.

A method of detecting objects using a pivotable sensor device is disclosed in DE 2006 008 275. A robot navigates here in that a laser scanner detects objects known to him from distance measurements and determines its own position from this using a stored map. The method is proposed because navigation by odometry and gyroscopics alone is too imprecise and is therefore not possible

EP 1 348 983 B1 describes an optoelectronic sensor having a position measurement device. An embodiment relates to a laser scanner for volume measurements of objects. The position measurement device serves the purpose of the sensor being able to be configured more easily, or even automatically, based on the detected spatial position or angular location. A GPS receiver and a gyroscopic sensor are inter alia named as examples for elements of the position measurement device. However, when using such external sensors, an additional wiring effort arises; in addition, the quality and the exact timing of the data must be known or a synchronization must be ensured.

Determining an object distance by a statistical evaluation of a plurality of individual pulses is known from DE 10 2007 013 714 A1. Influences by the self-movement of the sensor are not discussed here.

In EP 2 565 699 A2, a sensor, in particular a laser scanner, for the detection of objects in a monitoring zone by a rotatable scanning unit for the periodic scanning of the monitored zone is described. The sensor has an angle measurement unit for determining the angular position of the scanning unit relative to the housing of the sensor and an internal angular rate sensor for determining the orientation of the sensor relative to its environment, for example a gyroscope, a fiber optic gyroscope, or the like. An evaluation unit generates measured values that indicate whether and in which direction an object has been detected. In this respect, a correction unit is configured to determine orientation changes of the sensor with respect to the axis of rotation of the scanning unit and to compensate the influence of the orientation changes on the measured values. The effects of the self-movement, in particular of the self-rotation, of the sensor on the actual angles at which light is transmitted and received are therefore measured with the aid of the angular rate sensor. However, integrated angular rate sensors frequently have high noise levels that have to be compensated by long averaging times. Only a limited real time capability is thus present.

It is therefore the object of the invention to improve the sensor function under the influence of rotational movements.

This object is satisfied by an optoelectronic sensor and by a method for the detection of objects in a monitored zone in accordance with the respective independent claim. The invention here starts from the basic idea of determining a self-rotation of the sensor about an axis of rotation of a scanning unit of the sensor from a change of a measured angular speed of the scanning unit of the sensor in an optoelectronic sensor of the category.

An optoelectronic sensor in accordance with the invention for the detection of objects in a monitored zone, for example a laser scanner, first has a light transmitter for transmitting a transmitted light beam into the monitored zone. A scanning unit rotatable about an axis of rotation periodically scans the monitored zone by the transmitted light beam, with an angle measurement unit or an encoder determining an angular position of the scanning unit relative to the sensor. A light receiver generates received signals from light beams remitted by objects in the monitored zone. The scanning unit can be formed by a rotating deflection mirror that deflects the transmitted light beam into the monitored zone. The light transmitter and light receiver are here fixedly mounted in the sensor and do not co-execute the rotation of the scanning unit. In an alternative embodiment, the rotatable scanning unit can comprise the light transmitter and the light receiver. An evaluation unit of the sensor is configured to generate measured values that indicate whether and in which direction an object was detected with reference to the received signals and the angular position of the scanning unit.

In accordance with the invention, the sensor has a device that is configured to measure an angular speed at which the scanning unit rotates relative to the total sensor about the axis of rotation. Alternatively or additionally, the device can also be configured to measure a rotational frequency at which the scanning unit rotates relative to the total sensor about the axis of rotation. For reasons of clarity, the following statements relate to the angular speed of the scanning unit, but can also be applied to the rotational frequency in the same way. The device for measuring the angular speed can, for example, be a light barrier or also an inductively measuring sensor. The device for measuring the angular speed can in particular be formed by the angle measurement unit or the encoder of the sensor so that an additional device for measuring the angular speed is not necessary.

Due to the mass of inertia, the angular speed of the scanning unit is substantially constant or is an angular speed predefined by operating parameters of the sensor after a run-in phase. If there is a self-rotation of the entire sensor with a rotational component along the axis of rotation of the scanning unit, this produces a change in the measured angular speed of the scanning unit since it is measured relative to the entire sensor. The measured angular speed can in particular also differ from the predefined angular speed on a self-rotation of the sensor.

A correction unit is configured to determine a self-rotation of the sensor with respect to the axis of rotation of the scanning unit while using the measured angular speed of the scanning unit and to compensate the influence of the self-rotation of the sensor on the measured values. The determination of the self-rotation can, for example, be based on a change of the measured angular speed and/or on a comparison of the measured angular speed with the predefined angular speed.

The compensation can take place by calculation in that the knowledge of the difference between the angular resolution targeted by a rotation of the scanning unit and the actual angular resolution produced due to the superposition with the self-rotation of the sensor is determined and the measured values are then associated with these actual angles. Simultaneously or alternatively, however, the measurement recording can also already be self-corrected in that a correction unit acts on the movement of the scanning unit in a compensatory manner.

The invention has the advantage that no additional angular rate sensor is required for the measurement of a self-rotation of the sensor about the axis of rotation of the scanning unit of the sensor and the information on the self-rotation is practically present in real time. A defined object resolution is ensured due to the compensation of the self-rotation of the sensor. The sensor becomes more robust with respect to disruptive influences and then continues to deliver reliable measured values.

The correction unit is preferably configured to accelerate or decelerate the rotation of the scanning unit. Provision can thus be made that the angle steps between two measurements remain below a required angular resolution or even remain unchanged despite the self-rotation of the sensor. The acceleration or deceleration can specifically actually take place in the opposite direction to the self-rotation and to a degree corresponding to the self-rotation. The regular, cyclic movement of the scanning unit with respect to the sensor is thus effectively superposed with the negative self-rotation of the laser scanner. As a result, the angular dependence of the scan behaves as if the sensor is stationary. It can be supported by a regulation that stabilizes the rotational movement of the scanning unit while taking account of the orientation changes.

The correction unit is preferably configured to increase or decrease a pulse rate of the individual light pulses with a transmitted light beam having a plurality of consecutive individual light pulses. Provision can thus be made that the angle steps between two measurements remain below a required angular resolution or even unchanged despite the self-rotation of the sensor. The pulse rate can specifically be increased provided that the self-rotation of the sensor takes place in the same direction as the rotational movement of the scanning unit or can be reduced provided that the self-rotation of the sensor takes place in the opposite direction to the rotational movement of the scanning unit.

The correction unit is preferably configured to calculate the angular position of the scanning unit relative to the environment from the angular position of the scanning unit relative to the sensor and from the self-rotation of the sensor relative to the environment. In other words, the rotational movement of the scanning unit is related to an absolute global coordinate system instead of the co-moved coordinate system in which the angle measurement unit works. An estimation of which effects the self-rotation of the sensor has on the angular resolution is thus made possible. The decision can, for example, then follow that the current self-rotation is not critical to the sensor function.

The correction unit is preferably configured to correct the association of the measured values with a direction in that the direction is determined from the angular position of the scanning unit relative to the environment. What influence the self-rotation has is no longer only analyzed here, but the measured values are rather associated with the actual directions relative to the environment in which the transmitted light beam was transmitted. Distortions of the measured values due to self-rotations are thus corrected. The angle steps originally selected by the rotational movement with respect to the sensor are here consistently changed in accordance with the self-rotation both in the actual measurement recording and in the evaluation.

The correction unit is preferably configured to check the measured angular speed for plausibility. Minimal or maximum changes of the measured angular speed or maximum or minimal differences of the measured angular speed from the predefined angular speed can thus be predefined, for example. The self-rotation of the laser scanner can thus not exceed a maximum angular speed of a vehicle at which the laser scanner is mounted.

The evaluation unit is preferably configured to determine the distance from a scanned object from the time of flight of light between the transmission of the transmitted light beam and the reception of the remitted light beam so that the measured values each comprise an object distance and a direction. The laser scanner thus becomes a distance measuring laser scanner and each measured value comprises a direction and a distance, and thus complete two-dimensional polar coordinates.

The transmitted light beam piece preferably has a plurality of consecutive individual light pulses, wherein the evaluation unit is configured in each case to collect a group of individual received pulses corresponding to the transmitted individual light pulses for a measured value in a histogram and to determine the time of flight of light from the sensor to an object from the histogram and to determine the object distance therefrom. The laser scanner accordingly works with a statistical method in which not only one transmitted pulse, but rather a plurality of transmitted pulses form the base of the every measured value. Such a multi-pulse method has a considerably larger uniqueness range and a considerably smaller susceptibility to disruption because exact measurements are still possible by the statistical evaluation even with a very unfavorable signal-to-noise ratio.

The evaluation unit is preferably configured to determine the direction of the measured value from the angular positions of the scanning unit on transmission of the individual light pulses and/or on reception of the individual received pulses of the group collected in the associated histogram. With a conventional pulse-based laser scanner, the direction of the measured value is fixed by a single point in time at which the pulse is transmitted. If instead only a group of individual pulses together delivers a measured value, a common direction has to be assigned to this group, for example the angle at which the first, the last, or another individual pulse was transmitted, or its mean value.

The evaluation unit is preferably configured to select the groups such that the individual light pulses belonging to each group are transmitted within an angular segment corresponding to a predefined angular resolution of the sensor, wherein the angular segment is determined relative to the environment. On a regular rotational movement of the scanning unit, it appears sensible to combine a fixed number of individual pulses transmitted in a uniform cycle in a group to thus obtain regular angle steps for the measured values. If, however, a self-rotation of the sensor is superposed, it is no longer ensured that the group of individual pulses is also transmitted exactly within the targeted angular segment. There is then the possibility of varying the group size so that a fixed number of individual pulses is no longer decisive, but rather the association with an angular segment via the group affiliation. The statistical depth, that is the number of individua pulses that form a histogram, and thus the robustness toward disruptions are varied here. Despite the self-rotations, such a sensor rather robustly delivers one measured value per targeted angular segment so that the angular resolution becomes independent of self-rotations of the sensor.

The sensor is preferably configured as a safety laser scanner and has a safeguarding unit and a safe output, with the safeguarding unit being configured to recognize unauthorized object intrusions into protected zones and to thereupon output a safeguarding signal over the safe output. The sensor is thus equipped for use in safety engineering.

The correction unit or the safeguarding unit is preferably configured to check whether the measured values have a sufficient angular resolution after compensation by the correction unit and to otherwise output a shutdown signal over the safe output. In safety engineering applications, the errorfree function has to be maintained under all circumstances, that is also under external influences such as self-rotation. The sensor therefore checks whether the compensation was successful. A check is made here, for example, whether a sufficient angular resolution could be obtained by a change of the rotational movement of the scanning unit. Or a check is made whether a monitoring gap that is safety related has arisen after a reassociation of the measured values with the actual directions in a protected field changed by the self-rotation of the sensor by an increased angle step. Unlike in the prior art, the sensor does not have to shut down as a precaution as soon as the rotational movement of the scanning unit only very generally changes by more than a reserve. An evaluation can rather be made in a differentiated manner whether the angular resolution is still sufficient or, where this is not the case, whether the measurement function that has thereby deteriorated can result in a safety related problem at all. The system therefore shuts down more rarely and the availability is considerably improved.

In an advantageous further development, a vehicle having an optoelectronic sensor in accordance with the invention and having a navigation control is provided, the latter being configured to change the movement of the vehicle with reference to the measured values and in particular to stop or slow down the vehicle on reception of a safeguarding signal from the sensor. With mobile applications, the problems with disruptions of the angular resolution due to the self-rotation of the sensor are particularly present. This very particularly applies with driverless transport systems having a so-called omnidirectional drive, that is vehicles that can rotate on the spot so-to-say. The productivity of vehicles or driverless transport system is increased to the less frequent shutdown.

The navigation control is preferably configured to decelerate or to stop movements of the vehicle to ensure that the correction unit compensates the measured values within a demanded angular resolution. In this process, the sensor recognizes that too abrupt a movement or generally too fast a movement of the vehicle will result in a shutdown. Before an emergency shutdown therefore occurs, the drive of the vehicle is reduced so that the sensor maintains the required measurement accuracy and angular resolution. Standstill can thus be prevented in even more situations.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

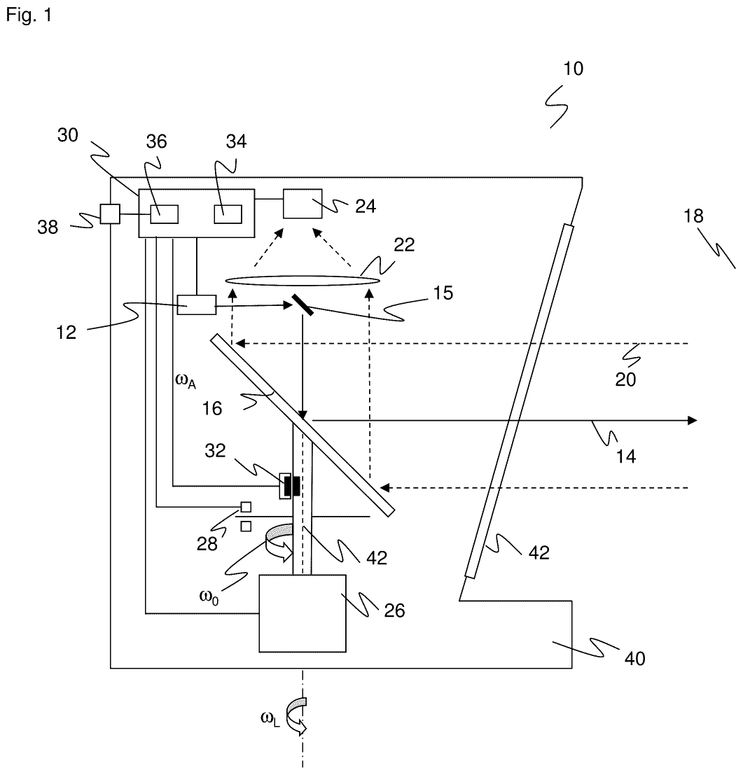

FIG. 1 a schematic sectional representation of a laser scanner; and

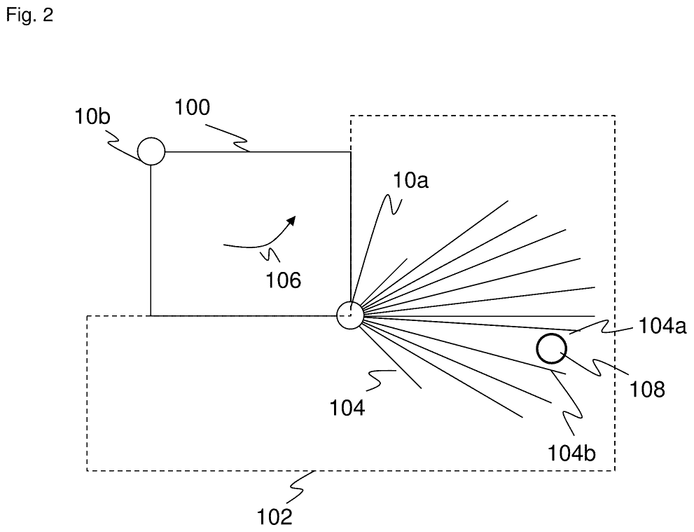

FIG. 2 a plan view of a vehicle having laser scanners in accordance with FIG. 1 mounted thereon.

FIG. 1 shows a schematic sectional representation through a laser scanner 10 in accordance with the invention. A light beam 14 which is generated by a light transmitter 12, for example by a laser, and which has individual light pulses, is directed into a monitored zone 18 via a deflection unit 15 and a scanning unit 16 and is there remitted by an object which may be present. The remitted light 20 again arrives back at the safety laser scanner 10 and is detected there by a light receiver 24, for example a photodiode, via the scanning unit 16 and by means of a reception optics 22.

The scanning unit 16 in the embodiment is designed as a rotating mirror that continuously rotates at a predefined angular speed ω0 about an axis of rotation 42 by a drive of a motor 26. The respective angular position of the scanning unit 16 is detected via an encoder 28 which, for example, comprises a code disk that is scanned by a forked light barrier. The light beam 14 generated by the light transmitter 12 thus sweeps over the monitored zone 18 generated by the rotational movement. If a reflected light signal 20 received by the light receiver 24 is received from the monitored zone 18, a conclusion can be drawn on the angular location of the object in the monitored zone 18 from the angular position of the scanning unit 16 by means of the encoder 28.

In addition, the tight of flight of the individual laser light pulses is determined from their transmission up to their reception after reflection at the object in the monitored zone 18. A conclusion is drawn on the distance of the object from the laser scanner 10 from the time of flight of light while using the speed of light. This evaluation takes place in an evaluation unit 30 which is connected for this purpose to the light transmitter 12, to the light receiver 24, to the motor 26 and to the encoder 28. Two-dimensional polar coordinates of all the objects in the monitored zone 18 are thus available via the angle and the distance.

As explained in more detail further below with reference to FIG. 2, the angular resolution of the laser scanner 10 can be influenced by self-rotations. The laser scanner 10 therefore has a device 32, for example an encoder, a light barrier, or an induction sensor, that measures an angular speed ωA of the scanning unit 16 relative to the housing 40 of the laser scanner 10. This function can generally also be taken over by the encoder 28, with the additional device 32 then being able to be omitted. The scanning unit 16 rotates at a predefined angular speed ω₀ that is substantially constant due to the mass of inertia of the scanning unit 16. On a self-rotation of the laser scanner 10 about the axis of rotation 42 of the scanning unit 16, the measured angular speed COA will differ from the predefined angular speed ω₀. The measured angular speed ω_{A} is further processed in a correction unit 34 to recognize a self-rotation of the laser scanner 10 and to determine and compensate changes of the angular resolution of the laser scanner 10. An angular speed ω_{L} of the self-rotation of the laser scanner 10 of ω_{L}=ω₀-ω_{A} in particular results provided that the scanning unit 16 and the laser scanner 10 rotate in the same direction.

In a safety engineering application, a safeguarding unit 36 compares the position of the detected objects with one or more protected fields whose geometry is predefined or configured in the safeguarding unit 36 by corresponding parameters. The safeguarding unit 36 thus recognizes whether a protected field has been infringed, that is whether an unpermitted object is located therein, and switches a safety output 38 (OSSD, output signal switching device) in dependence on the result. An emergency stop of a connected machine monitored by the laser scanner 10 is thereby triggered, for example. Such a laser scanner is configured as a safety laser scanner by satisfying the standards named in the introduction and by the measures required therefor.

All the named functional components are arranged in a housing 40 which has a front screen 42 in the region of the light exit and of the light entry. The functionality of the evaluation unit 30, of the correction unit 34, and of the safeguarding unit 36 can alternatively also be fully or partially implemented in a superior control.

FIG. 2 shows a schematic plan view of a vehicle 100 whose navigation is safeguarded by two laser scanners 10a-b. For reasons of better clarity, only one protected field 102 of the one laser scanner 10a is shown. Individual scans 104 of the laser scanner 10a are furthermore drawn schematically. In this respect, the angular distance between two scans 104 of, for example, 0.5°, that is regular per se, is disrupted by a change of direction indicated by an arrow 106 together with an associated self-rotation of the vehicle 100 so that individual scans 104a-b form a larger angle step. The object resolution is degraded in this manner. It is thereby possible that an object 108, for example in the form of a leg of a person located in front of the vehicle 100, is not or is no longer recognized in time. The safety function of the laser scanner 10a is disrupted.

The correction unit 34 now uses the information of the device 32 on the angular speed of the scanning unit 16 to judge whether a self-rotation of the laser scanner 10a impairs its function or to compensate the influence of the self-rotation on the measured values.

In an embodiment, the rotational movement of the scanning unit 16 is changed for this purpose by acting on the motor control of the motor 26. The rotational speed is, for example, accelerated or decelerated to a degree that compensate the unwanted additional rotation by self-rotation of the laser scanner 10b. As the simplest approach, the self-rotation of the laser scanner 10b is determined using the angular speed determined by the device 32 and is subtracted from the rotational movement of the scanning unit 16. However, all the information to implement a regulation using a more robust method that ensures a desired angular resolution is also available via the angular rate of the laser scanner 10a with respect to the environment and the angular position of the scanning unit 16 measured by the encoder 28.

In an embodiment, the angular position of the scanning unit 16 and the superposed self-rotation of the laser scanner 10a known via the change of the measured angular speed of the scanning unit with respect to its environment are offset with one another to determine the actual angular resolution, that is the absolute angular resolution with respect to the environment of the vehicle 100. A judgment can then also be made whether the self-rotation of the laser scanner 10a was critical for the measured values at least at a point in time and for an angular position. In addition, the measured object distances can be assigned to the actual angles determined with respect to the environment. The measured values are thus corrected by the influences of the self-rotation of the laser scanner 10a.

The two embodiments described in the last paragraphs can also be combined with one another. In this respect, the recording of measured values over the angular range is therefore homogenized in that a compensatory effect is exerted on the motor control of the motor 26. Remaining differences from a desired angular resolution are then recognized and/or corrected by calculation.

The correction unit 34, the safeguarding unit 36, or a superior control can then decide in an intelligent protected field evaluation whether the quality of the measured values thus obtained is sufficient to ensure the required object resolution at least within the relevant protected fields. If necessary, the vehicle 100 is then shut down or slowed down.

In an embodiment, the evaluation unit 30 does not determine the time of flight of individual light pulses, but rather determines the object distances using a pulse averaging method. Such a pulse averaging method is described, for example, in the initially named DE 10 2007 013 714 A1, to which reference is additionally made. In this respect, instead of a single relatively strong pulse per measured value, a plurality of weaker individual light pulses are transmitted whose received signal is not sufficient per se to stand out from the background level. The associated received pulses, that is the received signal in a time window following the transmission, are collected in a histogram. The useful signal stands out from the random interference level due to the plurality of events and can thus be detected substantially more robustly.

Since the scanning unit 16 continues to move between two respective individual pulses, a common angular direction has to be assigned to a respective group of individual pulses that form a histogram for a measured value. With a stationary laser scanner having a regular rotational movement of the scanning unit 16, groups of the same size are formed for this purpose, for example, that each cover an angular segment of the desired angular resolution. With an irregular rotational movement, there is the possibility of dynamically adapting the group sizes so that the number of individual pulses underlying a measured value admittedly varies, but not the angular segment. The correction unit 34 can thus keep the angular resolution constant while utilizing the information on the change of the angular speed of the scanning unit 16 measured by the device 32 by adapting the group sizes.

1. An optoelectronic sensor for the detection of objects in a monitored zone comprising a light transmitter for transmitting a transmitted light beam, a scanning unit rotatable about an axis of rotation for a periodic scanning of the monitored zone by the transmitted light beam, a light receiver for generating a received signal from light beams remitted by objects in the monitored zone, an angle measurement unit for determining the angular position of the scanning unit relative to the optoelectronic sensor, and an evaluation unit that is configured to generate measured values that indicate whether and in which direction an object has been detected using the received signals,
further comprising a device that is configured to measure an angular speed or rotational frequency of the scanning unit about the axis of rotation; and
a correction unit that is configured to determine a self-rotation of the optoelectronic sensor with respect to the axis of rotation of the scanning unit using the measured angular speed or the rotational frequency of the scanning unit and to compensate the influence of the self-rotation of the optoelectronic sensor on the measured values.

2. The optoelectronic sensor in accordance with claim 1,
wherein the optoelectronic sensor is a laser scanner.

3. The optoelectronic sensor in accordance with claim 1,
wherein the device is formed by the angle measurement unit.

4. The optoelectronic sensor in accordance with claim 1,
wherein the correction unit is configured to accelerate or decelerate the rotational movement of the deflection unit and to a degree corresponding to the self-rotation of the optoelectronic sensor.

5. The optoelectronic sensor in accordance with claim 4,
wherein the correction unit is configured to accelerate or decelerate the rotational movement of the deflection unit in the opposite direction to the self-rotation of the optoelectronic sensor.

6. The optoelectronic sensor in accordance with claim 1,
wherein the transmitted light beam has a plurality of consecutive individual light pulses and the correction unit is configured to increase or decrease a pulse rate of the individual light pulses.

7. The optoelectronic sensor in accordance with claim 1,
wherein the correction unit is configured to calculate the angular position of the deflection unit relative to the environment from the angular position of the deflection unit relative to the optoelectronic sensor and from the self-rotation of the optoelectronic sensor relative to the environment.

8. The optoelectronic sensor in accordance with claim 7,
wherein the correction unit is configured to correct the association of the measured values with a direction in that the direction is determined from the angular position of the deflection unit relative to the environment.

9. The optoelectronic sensor in accordance with claim 1,
wherein the evaluation unit is configured to determine the distance from a scanned object from the time of flight of light between the transmission of the transmitted light beam and the reception of the remitted light beam so that the measured values each comprise an object distance and a direction.

10. The optoelectronic sensor in accordance with claim 1,
wherein the transmitted light beam has a plurality of consecutive individual light pulses and the evaluation unit is configured in each case to collect a group of individual received pulses corresponding to the transmitted individual light pulses for a measured value in a time histogram and to determine the time of flight of light from the optoelectronic sensor to an object from the histogram and to determine the object distance therefrom.

11. The optoelectronic sensor in accordance with claim 10,
wherein the evaluation unit is configured to determine the direction of the measured value from the angular positions of the deflection unit on transmission of the individual light pulses and/or on reception of the individual received pulses of the group collected in the associated histogram.

12. The optoelectronic sensor in accordance with claim 10,
wherein the evaluation unit is configured to select the groups such that the individual light pulses belonging to each group are transmitted within an angular segment corresponding to a predefined angular resolution of the optoelectronic sensor, with the angular segment being determined relative to the environment.

13. The optoelectronic sensor in accordance with claim 1,
that is configured as a safety laser scanner and has a safeguarding unit and a safe output, wherein the safeguarding unit is configured to recognize unauthorized object intrusions into protected zones within the monitored zone and to thereupon output a safeguarding signal over the safe output.

14. The optoelectronic sensor in accordance with claim 13,
wherein the correction unit or the safeguarding unit is configured to check whether the measured values have a sufficient angular resolution after compensation by the correction unit and to otherwise output a shutdown signal over the safe output.

15. A vehicle having an optoelectronic sensor, the optoelectronic sensor comprising a light transmitter for transmitting a transmitted light beam, a scanning unit rotatable about an axis of rotation for a periodic scanning of the monitored zone by the transmitted light beam, a light receiver for generating a received signal from light beams remitted by objects in the monitored zone, an angle measurement unit for determining the angular position of the scanning unit relative to the optoelectronic sensor, and an evaluation unit that is configured to generate measured values that indicate whether and in which direction an object has been detected using the received signals,
further comprising a device that is configured to measure an angular speed or rotational frequency of the scanning unit about the axis of rotation; and
a correction unit that is configured to determine a self-rotation of the optoelectronic sensor with respect to the axis of rotation of the scanning unit using the measured angular speed or the rotational frequency of the scanning unit and to compensate the influence of the self-rotation of the optoelectronic sensor on the measured values.

16. The vehicle in accordance with claim 15, wherein the vehicle is a driverless transport system having an omnidirectional drive, having a navigation control which is configured to change the movement of the vehicle with reference to the measured values.

17. The vehicle in accordance with claim 16, wherein the navigation control is further configured to stop or slow down the vehicle on reception of a safeguarding signal from the optoelectronic sensor.

18. The vehicle in accordance with claim 16,
wherein the navigation control is configured to decelerate or to stop movements of the vehicle to ensure that the correction unit compensates the measured values within a demanded angular resolution.

19. A method of detecting objects in a monitored zone using an optoelectronic sensor is transmitted and periodically scans the monitored zone by a scanning unit rotating about an axis of rotation and a received signal is generated from light beams remitted at the objects in the monitored zone, wherein an angular position relative to the optoelectronic sensor is determined at which the transmitted light beam is transmitted, and wherein measured values that indicate whether and in which direction an object has been detected is generated with reference to the received signal and the measured values are corrected in that an influence of a self-rotation of the sensor about the axis of rotation on the angular position at which the transmitted light beam is transmitted is compensated,
wherein an angular speed or rotational frequency at which the scanning unit rotates about the axis of rotation is measured and the self-rotation of the optoelectronic sensor about the axis of rotation is determined using the measured angular speed and/or rotational frequency.
